(19) United States
(12) Patent Application Publication
(10) Pub. No.: US 2012/0057948 A1
(43) Pub. Date: Mar. 8, 2012

(54) RIVET BOLT

(76) Inventor: Byung-Kyu JEON, Daegu (KR)

(21) Appl. No.: 12/896,433

(22) Filed: Oct. 1, 2010

(30) Foreign Application Priority Data
Sep. 6, 2010 (KR) 10-2010-0087066

(51) Int. Cl. F16B 35/00

(52) U.S. Cl. 411/357

(57) ABSTRACT

A rivet bolt, which connects a plurality of connection members by rivet joints, is disclosed. The rivet bolt includes a retainer including a connection hole formed through a flange part and provided with a screw part, flat parts and inclined parts alternately arranged around the connection hole in the diagonal direction, and fastening pieces formed at the lower portion of the flange part by cutting, curved projections being formed at lower ends of the fastening pieces, and a bolt including a plurality of elevating pieces protruded from the lower surface of a bolt head so as to be inserted into the retainer, a screw thread formed at the upper end of a bolt body, a plurality of protruding pieces formed at the lower end of the bolt body at designated intervals, and a downwardly inclined extension part and an anti-separation piece formed at the lower portion of the bolt body.

### BACKGROUND OF THE INVENTION

1. Field of the Invention

The present invention relates to a rivet bolt which connects a plurality of connection members (plates, sheets, non-specific structures, etc.) by rivet joints, and more particularly to a rivet bolt which firmly connects a retainer and a bolt to connection members after provisional connection between the retainer and the bolt and thus prevents the bolt from being easily separated from the retainer so as to prevent components of the rivet bolt from being lost.

2. Description of the Related Art

In general, when nuts are not used to connect an interior panel, which is made of resin or non-woven fabric and mainly employed in vehicles, to a vehicle frame panel, rivet bolts are widely used now to connect the interior panel to the vehicle frame panel by rivet joints.

For example, Korean Utility Model Registration No 386889 discloses a rivet bolt. Such a conventional rivet bolt includes a retainer and a bolt, and is configured such that, when the bolt is inserted into a connection hole of the retainer and is then pushed into the connection hole, fastening parts formed at the lower portion of the retainer by cutting are expanded outwards so as to connect a plurality of connection members.

Thereby, since the connection members are connected by rivet joints and thus are conveniently connected without a separate riveting process, the conventional rivet bolt improves operating efficiency. However, when the bolt expands the fastening parts of the retainer, a worker must inconveniently rotate a screw part of the bolt several times so as to push the bolt into the connection hole of the retainer. Further, since fastening between the screw part of the bolt and a protruding screw thread provided within the retainer is not properly achieved due to expansion of the fastening parts, an expanded state of the fastening parts cannot be continuously maintained and thus the rivet bolt may be easily separated from the connection members.

Moreover, although the retainer and the bolt are provisionally connected without separation by fastening the screw part of the bolt to the retainer, when the bolt is pulled, the bolt is easily separated from the retainer and is frequently lost during operation, thereby causing a worker to purchase components of the rivet bolt individually.

### SUMMARY OF THE INVENTION

Therefore, the present invention has been made in view of the above problems, and it is an object of the present invention to provide a rivet bolt which prevents a retainer and a bolt from being lost during provisional connection between the retainer and the bolt, and enables the bolt to be easily separated from the retainer during release of locking of the bolt with the retainer, while more simply and firmly connecting the retainer and the bolt during connection of a plurality of connection members, so as to improve operating efficiency.

In accordance with the present invention, the above and other objects can be accomplished by the provision of a rivet bolt, which connects a plurality of connection members by rivet joints, including a retainer including a connection hole formed through a flange part and provided with a screw part formed on the inner surface of the flange part, flat parts and inclined parts alternately arranged around the connection hole in the diagonal direction, and fastening pieces formed at the lower portion of the flange part by cutting, curved projections being formed at lower ends of the fastening pieces, and a bolt including a plurality of elevating pieces protruded from the lower surface of a bolt head so as to be inserted into the retainer, a screw thread formed at the upper end of a bolt body provided under the bolt head, a plurality of protruding pieces formed on the outer surface of the lower end of the bolt body at designated intervals, and a downwardly inclined extension part and an anti-separation piece formed at the lower portion of the bolt body under the protruding pieces.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a rivet bolt in accordance with an embodiment of the present invention;

FIG. 2 is an exploded perspective view of FIG. 1;

FIG. 3 is an exploded sectional view of the rivet bolt in accordance with the embodiment of the present invention;

FIG. 4 is a sectional view of the rivet bolt, which is connected to connection members, in accordance with the embodiment of the present invention;

FIG. 5 is a sectional view of the rivet bolt, which releases connection with the connection members, in accordance with the embodiment of the present invention;

FIGS. 6(a) and 6(b) are sectional views of respective essential parts in a connection state between a retainer and a bolt of the rivet bolt in accordance with the embodiment of the present invention; and

FIGS. 7(a) and 7(b) are sectional views of the respective essential parts in a connection release state between the retainer and the bolt of the rivet bolt in accordance with the embodiment of the present invention.

### DETAILED DESCRIPTION OF THE INVENTION

Now, a preferred embodiment of the present invention will be described in detail with reference to the annexed drawings.

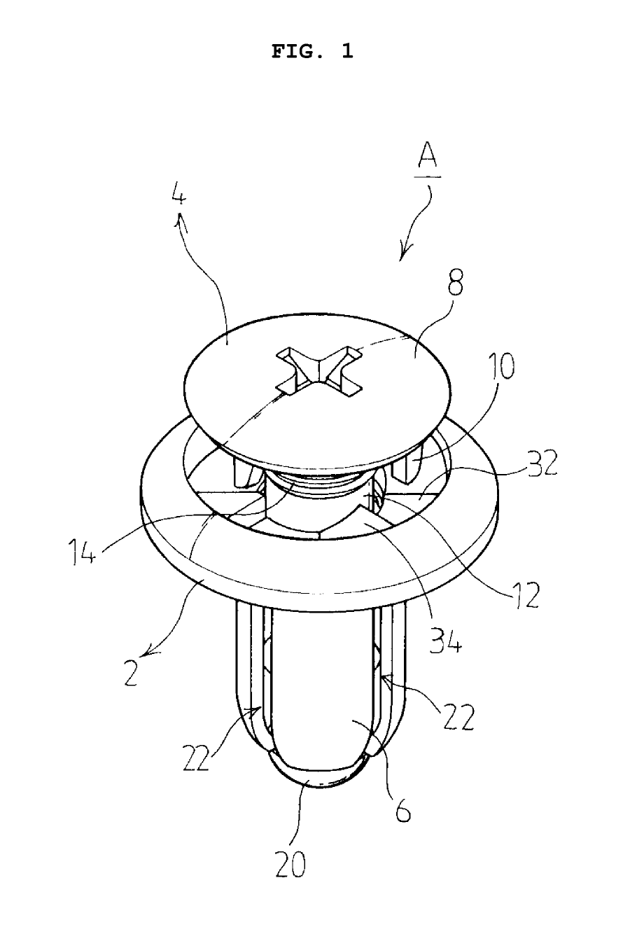

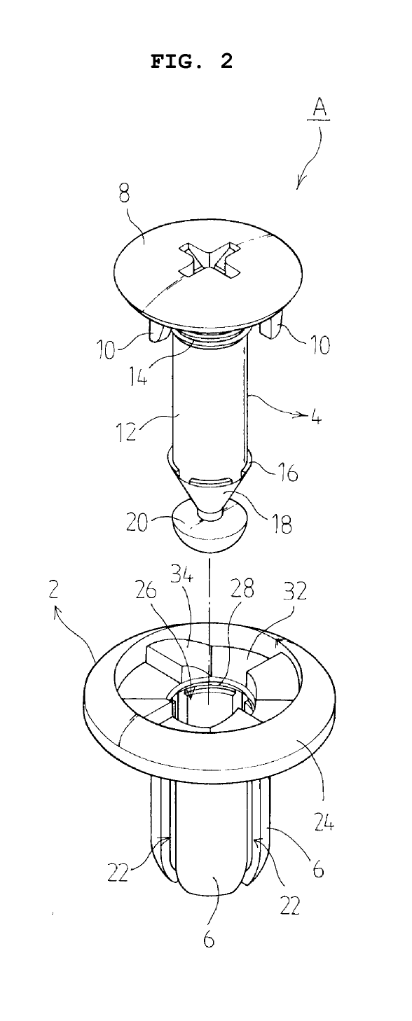

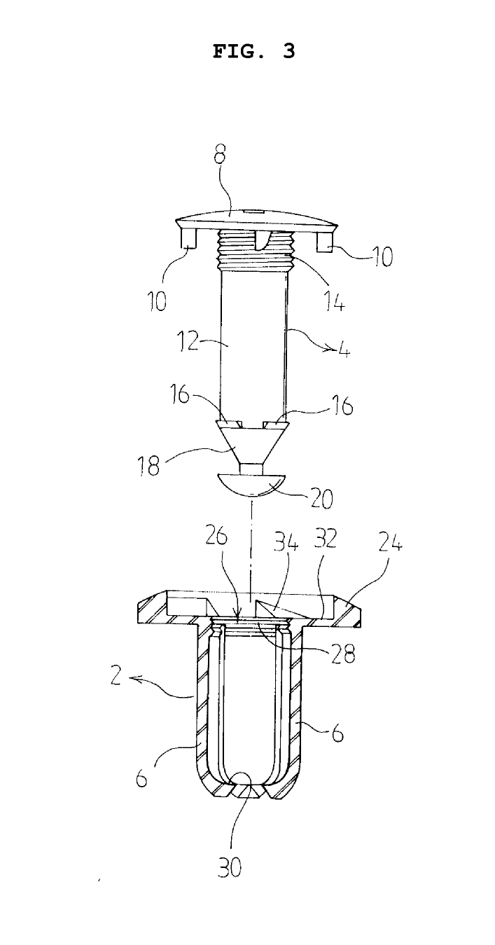

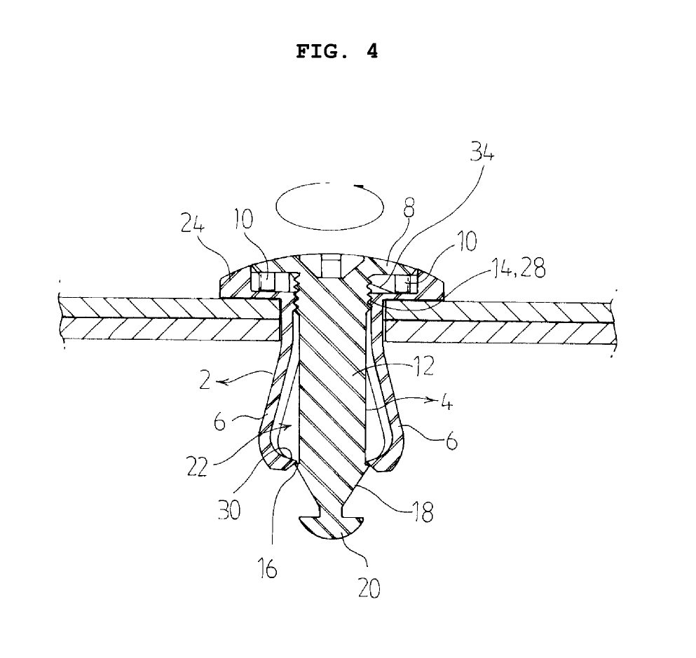

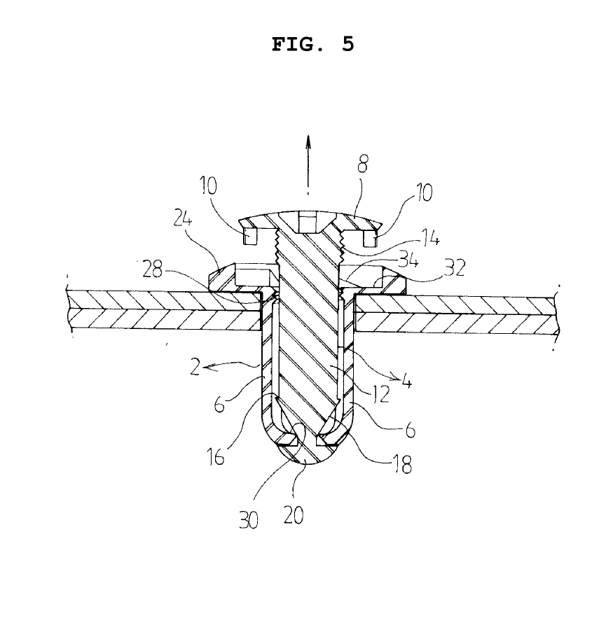

FIG. 1 is a perspective view of a rivet bolt in accordance with an embodiment of the present invention, FIG. 2 is an exploded perspective view of FIG. 1, and FIG. 3 is an exploded sectional view of the rivet bolt in accordance with the embodiment of the present invention. A rivet bolt A in accordance with the embodiment of the present invention includes a retainer 2 holding a plurality of connection members (plates, sheets, non-specific structures, etc.), and a bolt 4 connected to the retainer 2 without separation to expand fastening pieces 6 formed at the lower portion of the retainer 2 by cutting, as shown in FIGS. 4 and 5, so as to connect the connection members by rivet joints.

In more detail, the retainer 2 and the bolt 4 of the rivet bolt A of the embodiment of the present invention are formed by molding using a synthetic resin. The bolt 4 includes a round bolt head 8 provided with a cross-shaped groove formed at the upper surface thereof so as to be tightened and thus connected to the retainer 2, a plurality of elevating pieces 10 protruding from the lower surface of the bolt head 8 and being diagonally opposite to each other so as to enable the bolt 4 to be elevated when the connection between the bolt 4 and the retainer 2 is released, and a cylindrical bolt body 12 formed integrally with the lower portion of the bolt head 8 and having a length corresponding to the length of the retainer 2.

Preferably, a screw thread 14 screw-connected with the retainer 2 is formed at the upper end of the bolt body 12. If the bolt 4 is connected with the retainer 2 using an electric screwdriver, the screw thread 14 formed on the bolt body 12 may be formed to have a larger width than that shown in the drawings. A plurality of protruding pieces 16 is protruded from the lower end of the bolt body at an equal interval so as to surround the external surface of the bolt body 12. The protruding pieces 16 are located on vertical lines being diagonal to the respective elevating pieces 10, provided on the lower surface of the bolt head 8, at an angle of 45°. A downwardly included extension part 18 is extended from the protruding pieces 16, and a semi-spherical anti-separation piece 20 is formed at the front end of the extension part 18 so as to enable the bolt 4 to be locked with the retainer 2 when the bolt 4 is provisionally connected with the retainer 2.

A configuration of the retainer 2 provisionally connected with the bolt 4 of the rivet bolt A is as follows.

The retainer 2 includes a plurality of fastening pieces 6 having a designated length and separated from each other by cutting parts 22 formed at the lower portion of the retainer 2, a flange part 24 having a larger diameter than that of the bolt head 8 and formed integrally with the upper portions of the fastening pieces 6, and a connection hole 26 formed at the center of the inside of the flange part 24 so as to pass through the fastening pieces 6 such that the bolt body 12 is inserted into the connection hole 26.

A screw part 28 is formed on the inner surface of the connection hole 26 of the flange part 24 so as to be screw-connected with the screw thread 14 of the bolt body 12, the lower ends of the fastening pieces 6 are inwardly curved so as to be easily connected to through holes of the connection members, and projections 30 are formed at the lower ends of the fastening pieces 6 so as to be locked with the protruding pieces 16 formed on the bolt body 12 to expand the fastening pieces 6.

A plurality of flat parts 32 and a plurality of upwardly inclined parts 34 are alternately connected around the connection hole 26 of the flange part 24. Here, the inclined parts 34 are arranged at intervals of an angle of 90° in the diagonal direction, and contact the elevating pieces 10 provided on the lower surface of the bolt head 8 seated on the upper surface of the flange part 24, thereby allowing the bolt 4 to easily get out of the retainer 2 when the provisional connection between the bolt 4 and the retainer 2 is released.

Hereinafter, an operation to connect a plurality of connection members using the rivet bolt A in accordance with the embodiment of the present invention will be described.

With reference to FIGS. 4 to 7, the rivet bolt A in the provisional connection state in which the bolt body 12 of the bolt 4 is fastened into the connection groove 26 of the retainer 2 is inserted into through holes formed through plural connection members, and then a worker inserts a screwdriver into the cross-shaped groove of the bolt head 8 protruded from the flange part 24 of the retainer 2 and rotates the screwdriver so as to tighten the bolt head 8. Here, the screw thread 14 located at the upper portion of the bolt body 12 is screw-connected with the screw part 28 formed on the inner surface of the flange part 24, and simultaneously, the downwardly inclined extension part 18 formed at the lower portion of the bolt body 12 moves forwards and expands the contracted fastening pieces 6 outwardly.

Thereafter, when the bolt body 12 further moves forwards, the projections 30 formed at the lower ends of the fastening pieces 6 are respectively locked with the protruding pieces 16 provided above the extension part 18 and thus more firmly hold the expanded fastening pieces 16, thereby allowing the plurality of connection members to be connected by rivet joints, as shown in FIG. 4.

Therefore, when the bolt 4 in accordance with the embodiment of the present invention is inserted into the retainer 2 to expand the fastening pieces 6, the bolt 4 is screw-connected to the retainer 2 through the screw thread 14 and the screw part 28 and the expanded fastening pieces are locked with the protruding pieces 16 of the bolt body 12, thereby achieving dual fastening of the bolt 4 and the retainer 2. Thereby, the rivet bolt A is firmly combined with the connection members so as not to be separated from the connection members even by external impact.

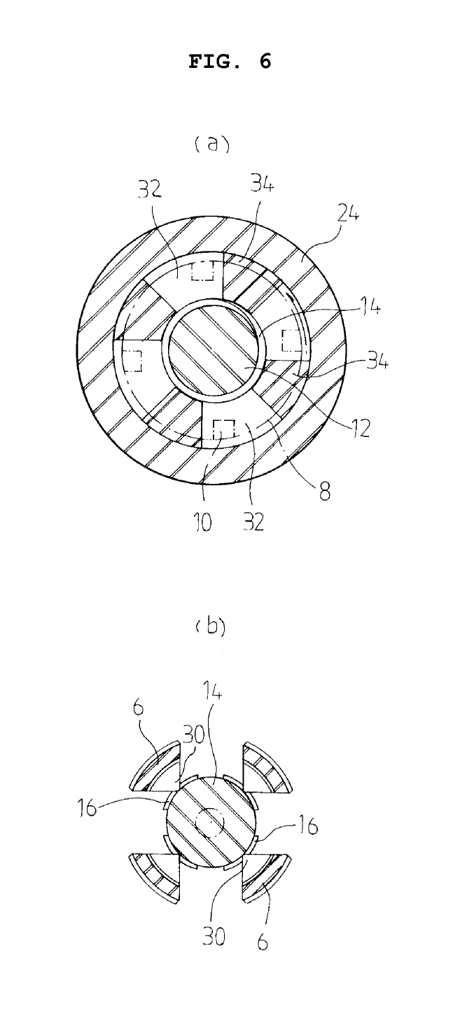

When the connection of the rivet bolt A with the connection members has been completed, as shown in FIGS. 6(a) and 6(b), the elevating pieces 10 protruded from the lower surface of the bolt head 8 are located on the flat parts 32 provided on the inner surface of the flange part 24 and thus the bolt head 8 is received in the flange part 24, and the protruding pieces 16 located on the vertical lines being diagonal to the respective elevating pieces 10 at an angle of 45° are locked with the projections 30 of the expanded fastening pieces 6.

Under the above state, in order to separate the rivet bolt A from the connection members, the worker inserts the screwdriver into the cross-shaped groove of the bolt head 8 and rotates the screwdriver in a direction opposite to the tightening direction. Thereby, the connection of the screw thread 14 of the bolt body 12 with the screw part 28 is released, and simultaneously, the fastening pieces 6 locked with the protruding pieces 16 at positions where the bolt body 12 is rotated at an angle of 45° become located in vacant spaces between the protruding pieces 16, and thus the locking of the fastening pieces 6 with the protruding pieces 16 is released. Then, as shown in FIG. 5, the expanded fastening pieces 6 are contracted to their original positions and are located on the upper surface of the anti-separation piece 20.

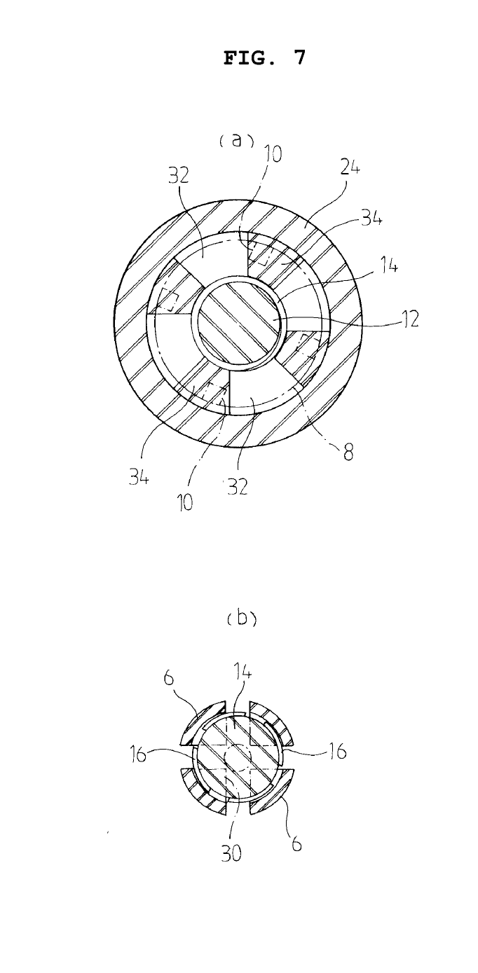

That is to say, when the bolt head 8 is rotated in the direction opposite to the tightening direction, as shown in FIGS. 7(a) and 7(b), the elevating pieces 10 provided on the lower surface of the bolt head 8 moves from the flat parts 32 to the upwardly inclined parts 34 within the flange part 24, and thus, when the bolt head 8 gets out of the flange part 24, the locking of the screw thread 14 with the screw part 28 of the flange part 24 and the locking of the protruding pieces 16 with the projections 30 of the fastening pieces 6 are already released by the rotation of the bolt body 12, respectively.

Therefore, the elevating pieces 10 ascend along the inclined parts 34, thereby enabling the bolt head 8 to be completely separated from the flange part 24 and simultaneously enabling the bolt 4 to be automatically protruded from the retainer 2. Thereby, the worker may simply release the connection of the bolt 4 with the retainer 2 simply by rotating the bolt 4 at a small angle without great efforts.

Further, when the connection of the bolt 4 with the retainer 2 is released, the fastening pieces 6 are contracted and locked with the anti-separation piece 20 provided at the lower end of the bolt body 12, and thus the provisional connection state of the bolt 4 with the retainer 2 is maintained, thereby preventing the bolt 4 from being in danger of being lost during operation.

Moreover, although an electric screwdriver is used to increase operating efficiency during the release of the connection of the bolt 4 with the retainer 2, the fastening pieces 6 of the retainer 2 are located between the extension part 18 and the anti-separation piece 20 provided at the lower end of the bolt 4, and thus even when the bolt 4 gets out of the retainer 2 and is rotated after the release of the screw-connection of the bolt 4 with the retainer 2 during the momentary release of the connection of the bolt 4 with the retainer 2 using the electric screwdriver, only the bolt 2 is rotated at idle and the bolt 2 and the retainer 4 do not interfere with each other, thereby preventing damage to components caused by melting of the retainer 2 or sticking of the retainer 2 to the connection members due to friction of the retainer 2 with the connection members.

As apparent from the above description, the present invention provides a rivet bolt which simply screw-connects a bolt with a retainer, connecting a plurality of connection members by rivet joints, simply by rotating the bolt even at a small angle, and causes protruding pieces of a bolt body and fastening pieces of the retainer, which are expanded when the bolt body moves forwards, to be locked with each other, thereby achieving dual fastening of the bolt and the retainer and thus continuously keeping the expanded fastening pieces. Further, when a worker releases the connection of the bolt with the retainer using a screwdriver, elevating pieces provided on the lower surface of a bolt head ascend along inclined parts within a flange part through rotation of the bolt head to release the connection of the bolt with the retainer and thus the bolt is easily protruded from the retainer without great efforts of the worker, thereby increasing operating efficiency.

Further, even after the connection of the bolt with the retainer is released, the fastening pieces of the retainer are contracted and locked with an anti-separation piece provided at the lower end of the bolt body, and a state in which the bolt and the retainer are provisionally connected is maintained, thereby preventing the bolt and the retainer from being lost.

Moreover, even when the worker uses an electric screwdriver to release the connection of the bolt with the retainer, only the bolt is rotated at idle within the retainer, thereby preventing damage to components caused by melting of the retainer or sticking of the retainer to the connection members due to friction between the retainer and the connection members.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A rivet bolt, which connects a plurality of connection members by rivet joints, comprising:
a retainer including a connection hole formed through a flange part and provided with a screw part formed on the inner surface of the flange part, flat parts and inclined parts alternately arranged around the connection hole in the diagonal direction, and fastening pieces formed at the lower portion of the flange part by cutting, curved projections being formed at lower ends of the fastening pieces; and
a bolt including a plurality of elevating pieces protruded from the lower surface of a bolt head so as to be inserted into the retainer, a screw thread formed at the upper end of a bolt body provided under the bolt head, a plurality of protruding pieces formed on the outer surface of the lower end of the bolt body at designated intervals, and a downwardly inclined extension part and an anti-separation piece formed at the lower portion of the bolt body under the protruding pieces.

2. The rivet bolt according to claim 1, wherein the protruding pieces of the bolt body are located on vertical lines being diagonal to the elevating pieces, protruded form the lower surface of the bolt head, at an angle of 45°.

3. The rivet bolt according to claim 1, wherein the anti-separation piece provided on the lower end of the bolt body is formed in a semi-spherical shape such that the fastening pieces of the retainer are locked on the upper surface of the anti-separation piece.
